(19) United States
(12) Patent Application Publication
(10) Pub. No.: US 2017/0020342 A1
(43) Pub. Date: Jan. 26, 2017

(54) GRATER

(71) Applicants: Michael Wein, Houston, TX (US); Stephen Douglas Alexander, Burnet, TX (US)

(72) Inventors: Michael Wein, Houston, TX (US); Stephen Douglas Alexander, Burnet, TX (US)

(21) Appl. No.: 15/217,890

(22) Filed: Jul. 22, 2016

Related U.S. Application Data
(60) Provisional application No. 62/195,757, filed on Jul. 22, 2015.

(51) Int. Cl. A47J 43/25

(52) U.S. Cl. CPC A47J 43/25

(57) ABSTRACT

A grater for grinding and cutting plant matter or medicines having a plate with a plurality of first identical shapes and a plurality of second identical shapes. The plurality of first identical shapes can be cut into the plate at a depth from 5 percent to 75 percent of the plate thickness. The plurality of second identical shapes can be positioned adjacent the first plurality of identical shapes forming a textured pattern on the plate. The plurality of second identical shapes can be sized to fit within a first inner diameter and extend through the plate, wherein a first portion of plant matter or medicine is broken down through grinding with the plurality of first identical shapes while a second portion of plant matter or medicine is cut using the plurality of second identical shapes before passing through the plurality of second identical shapes forming a ground and cut material.

### CROSS REFERENCE TO RELATED APPLICATION

The current application claims priority to and the benefit of co-pending U.S. Provisional Patent Application Ser. No. 62/195,757 filed on Jul. 22, 2015, entitled “GRATER”. This reference is hereby incorporated in its entirety.

### FIELD

The present embodiments generally relate to a grater for herbs, cutting plant matter, and for grinding pills and other solid medicines into a ground material.

### BACKGROUND

A need exists for an easy to use grater that does not cut a user's hands and can be used to make large portions of medicine smaller.

A further need exists for a ferromagnetic grater that can mince, grind and cut material in less than two swipes of the hand simultaneously with little or no pressure applied by the hand.

The present embodiments meet these needs.

### BRIEF DESCRIPTION OF THE DRAWINGS

The detailed description will be better understood in conjunction with the accompanying drawings as follows:

FIG. 1 is a perspective view of the grater according to one or more embodiments.

FIG. 2A depicts a first planar surface of the grater according to one or more embodiments.

FIG. 2B depicts a second planar surface opposite the first planar surface according to one or more embodiments.

FIG. 3A depicts a cut view of the plate along lines A-A shown in FIG. 2A.

FIG. 3B depicts a detailed view of the plate as shown in FIG. 3A.

FIG. 4 is a side view of the grater with an integral lighter according to one or more embodiments.

### The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a grater for herbs, cutting plant matter, and for grinding pills and other solid medicines into a ground material.

The grater can function but is not limited as an herb grinder, a pill shaver, a medication grinder, a vegetable grater, a truffle slicer, and combinations thereof.

In embodiments, the grater can be used for grinding and cutting plant matter or medicines simultaneously.

The grinder can have a plate. In embodiments, the grinder can have a plurality of first identical shapes cut into the plate at a depth from 5 percent to 75 percent of the thickness of the plate, but not through the plate.

Each first identical shape of the plurality of first identical shapes can have a first inner diameter.

The plate can have a plurality of second identical shapes positioned adjacent the plurality of first identical shapes forming a textured pattern on the plate.

Each second identical shape of the plurality of second identical shapes can be sized to fit within the first inner diameter and extend through the plate.

In embodiments, the plurality of second identical shapes can have an identical shape matching the plurality of first identical shapes. In other embodiments, the plurality of first identical shapes and the plurality of second identical shapes can have different shapes.

In embodiments, the plurality of second identical shapes can be equal to or less than the size of the plurality of first identical shapes.

In embodiments, the plurality of first identical shapes can be formed by but not limited to chemical etching, stamping, laser etching, photo etching, etching, or other known manufacturing processes that allow for a controlled portion of plate material to be removed from the first planar surface without passing through the second planar surface.

In embodiments, the plurality of first identical shapes and the plurality of second identical shapes can be formed on the plate in a 1:1 ratio of first identical shapes to second identical shapes.

In embodiments, the plurality of first identical shapes, the plurality of second identical shapes, or both the plurality of first and second identical shapes can be polygonal forming a honeycomb pattern.

In embodiments, the plurality of second identical shapes can increase in size by row on the plate, such as from 1 percent to 5 percent.

In embodiments, the plurality of first identical shapes and the plurality of second identical shapes can both be at least one of but is not limited to: a circular shape, an elliptical shape, and combinations thereof.

In embodiments, the plurality of first identical shapes and the plurality of second identical shapes can have at least one of but is not limited to: a quadrilateral shape, a diamond shape, a pentagonal shape, a hexagonal shape, a heptagonal shape, an octagonal shape, a triangular shape, and combinations thereof.

In embodiments, the plate can be flat, curved or bent. In embodiments, the plate thickness can vary depending upon use, so long as the plate does not break or crease.

In embodiments, the grater can have a grinding surface built into the plate, those additional functions of the grinding surface can be for opening bottles, screwing screws, scraping, sifting, shredding, stirring, scooping, slicing, or any other function that can be built into a plate that has a thickness from 0.01 mm to 5 mm thick.

In embodiment, the plate can be removably inserted into a heat resistant cover that can cover at least a portion of at least one of: the first planar surface, the second planar surface, the third planar surface, and a portable item having a fourth planar surface.

In operation, a first portion of plant matter or medicine can be broken down through grinding with the plurality of first identical shapes while a second portion of plant matter can be cut using the plurality of second identical shapes simultaneously before passing the plant matter or medicine through the plurality of second identical shapes forming a ground and cut material.

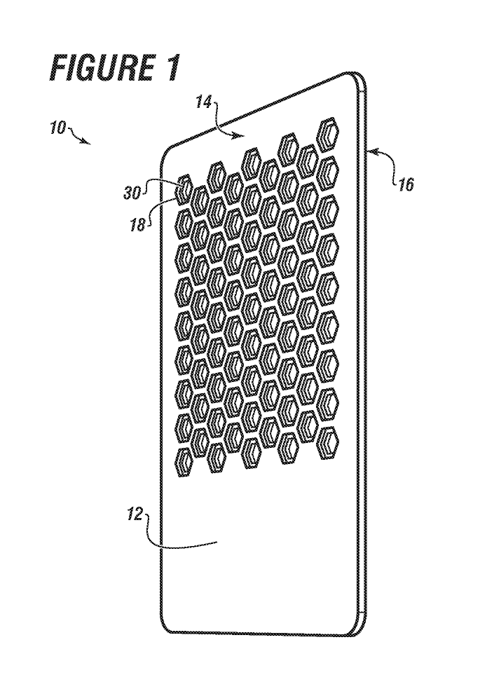

Turning now to the Figures, FIG. 1 is a perspective view of the grater according to one or more embodiments.

The grater 10 can have a plate 12, wherein the plate can have a first planar surface 14 and a second planar surface 16.

The plate 12 can be made from at least one of, but is not limited to: a ferromagnetic material, a metal material, a plastic material, a composite material, a rubberized material, a heat resistant material, a wooden material, a plant-based material, a stone material, a quartz material, or combinations thereof.

A plurality of first identical shapes 18 can be etched or cut into the plate 12 at a depth from 5 percent to 75 percent of the thickness of the plate, but not through the plate.

A plurality of second identical shapes 30 can be positioned adjacent the plurality of first identical shapes 18 forming a textured pattern on the plate 12.

Each second identical shape can be sized to fit within a first inner diameter and extend through the plate.

In embodiments, the plurality of second identical shapes can have an identical shape matching the plurality of first identical shapes.

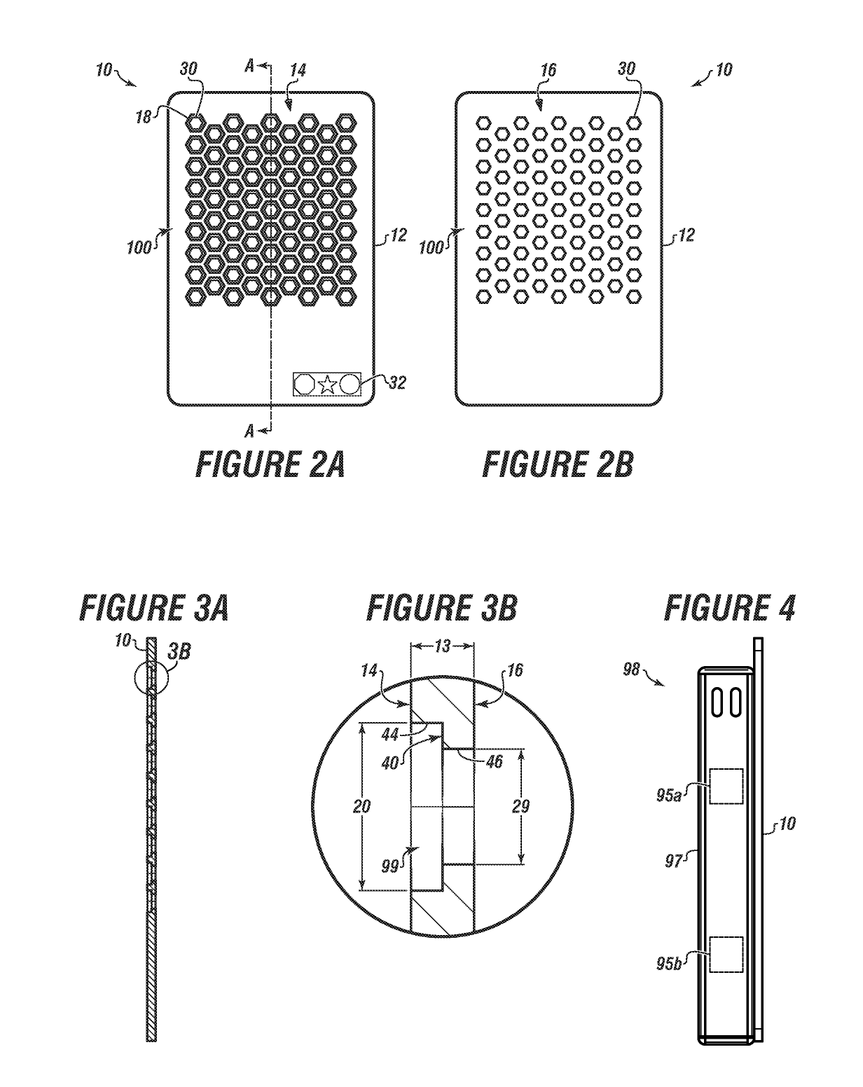

FIG. 2A depicts a first planar surface of the grater according to one or more embodiments.

The grater 10 is shown with the plate 12 having the first planar surface 14.

The first planar surface 14 can have a plurality of etched symbols 32. The plurality of etched symbols can form a roughened zone that simultaneously functions as a message board and a grinding surface.

The plurality of etched symbols can be formed on the first planar surface, the second planar surface, or both the first planar surface and the second planar surface.

In embodiments, the plurality of second identical shapes 30 can be surrounded by a frame area 100 on the plate 12.

The plurality of second identical shapes 30 are shown inside the plurality of first identical shapes 18 on the plate 12.

FIG. 2B depicts a second planar surface opposite the first planar surface according to one or more embodiments.

The grater 10 is shown with the plate 12 having the second planar surface 16.

In embodiments, the plurality of second identical shapes 30 can be surrounded by a frame area 100 on the plate 12.

In embodiments, the plurality of second identical shapes can have an inner diameter from 0.5 mm to 15 mm.

FIG. 3A depicts a cut view of the plate along lines A-A shown in FIG. 2A and FIG. 3B depicts a detailed view of the cut view shown in FIG. 3A.

Referring to FIGS. 3A and 3B, the grater 10 is shown with the first planar surface 14 and the second planar surface 16 of the plate with a plate thickness 13.

In embodiments, the plate thickness 13 can be from 0.1 mm to 5 mm.

A first side wall 44 can connect between the first planar surface 14 and a planar surface 40 of the plurality of second identical shape at an angle from 45 degrees to 135 degrees.

A second wall 46 can connect between the second planar surface 16 and the planar surface 40 of the plurality of second identical shape at angle from 45 degrees to 135 degrees.

In an embodiment, the first wall and second wall connecting the first planar surface, the second planar surface and a third planar surface can have angles ranging from 5 degrees to 175 degrees. The more acute the angle, the sharper the edge.

In an embodiment, the first wall and second wall connecting the first planar surface, the second planar surface and the third planar surface can have angles that are sharp enough to cut plant material but not so sharp that they can cut human skin. This creates a safety feature that is different than many graters currently on the market.

In embodiments, the first planar surface 14 and the planar surface 40 of the plurality of can be parallel.

Each second identical shape of the plurality of second identical shapes can form a hole 99, which can penetrate through the plate between the first planar surface 14 and the second planar surface 16.

Each first identical shape of the plurality of first identical shapes can have a first inner diameter 20. In embodiments, the first inner diameter 20 can range from 0.5 mm to 15 mm.

Each second identical shape of the plurality of second identical shapes can have an inner diameter 29. In embodiments, the inner diameter 29 can range from 0.5 mm to 15 mm.

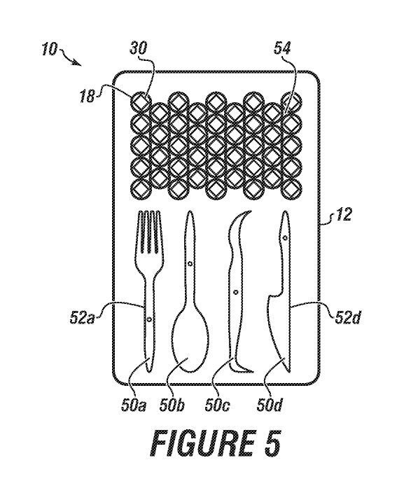

FIG. 4 is a side view of the grater with an integral lighter according to one or more embodiments.

In embodiments, the grater 10 can include an integral lighter 98

A magnetic lighter system 97 can magnetically secure to the grater 10 using at least one embedded magnet 95a and 95b forming the integral lighter with grater.

The term “magnetic lighter system” as used herein can refer to either a magnetic lighter sleeve over a pocket lighter or a pocket lighter with a magnet embedded in the pocket lighter housing. A pocket lighter can contain a housing, which can contain fuel, like butane, or a striking surface to create a controllable flame, such as an electric ignition system or flint wheel.

In embodiments, the magnetic lighter system can include at least one of: a lighter cover that fits over at least a portion of the lighter, the lighter cover comprising at least one additional embedded magnet, a lighter wrap that wraps around at least a portion of the lighter, the lighter wrap comprising the at least one magnet removably secured to the lighter beneath the lighter wrap or a lighter sleeve that slides over at least a portion of the lighter, the lighter sleeve comprising the at least one embedded magnet.

In embodiments, the grater with the magnetic lighter system can have a first surface, a second surface opposite the first surface, a second plurality of first identical shapes cut into the ferromagnetic plate at a depth from 5 percent to 95 percent of the ferromagnetic plate thickness, but not through the ferromagnetic plate, each first identical shape of the second plurality of first identical shapes having a second inner diameter; and a second plurality of second identical shapes positioned adjacent the second plurality of first identical shapes forming a second textured pattern on the ferromagnetic plate, each second identical shape of the second plurality of the second identical shapes sized to fit within the second inner diameter of the second plurality of first identical shapes and extending through the ferromagnetic plate.

In this embodiment, the first portion of plant matter or medicine is broken down through grinding with the second plurality of first identical shapes while the second portion of plant matter or medicine is cut using the second plurality of second identical shapes before passing through the second plurality of second identical shapes forming the ground and cut material.

FIG. 5 depicts the plate of the grater with removable portable items according to one or more embodiments.

The plate 12 of the grater 10 is shown having at least one removable portable item 50a, 50b, 50c and 50d. In embodiments, the plate can be removably attached to at least one portable item having a fourth planar surface 52a-52d. Examples of portable items can include a spoon, a fork, a spork, a knife, a packing tool, a poker tool, a scraper tool, a tweezer tool, a needle tool, a scalpel tool, a small portable tool, a small portable utensil, a lighter, a lighter sleeve, a portable fuel tank, a smoking apparatus, an ashtray, and a herb grinder.

The grinder can include a pattern of raised grating points 54, which can be formed between the plurality of first identical shapes. In embodiments, the pattern of raised grinding points 54 can be formed triangulated between three first identical shapes.

In embodiments, the pattern of raised grinding points 54 can be formed between the plurality of first identical shapes can be triangular in shape.

In embodiments where the plurality of first identical shapes are circular, the circular shapes can be positioned as close to each other as possible without overlapping. In this example, the shape formed between each set of three circular shapes has three sharp edges that form is an approximately triangular shape. The pattern of raised grinding point is very helpful in the functionality of the grater. In this example, the plurality of second identical shapes can be square. These identical shapes pass all the way through the plate forming square holes. One of the benefits of having polygonal shaped holes is that they form additional slicing surfaces at each vertices. In many ways these angular slicing vertices provide a more efficient grinding, cutting and or slicing function.

In another embodiment, the plurality of first identical shapes can be circular and can be positioned so close to each other that they overlap. In this example, the grinding points formed on the first planar surface have three sharp edges, but can be smaller in size.

In embodiments, the angles formed between the identical shapes can help cut plant material or medicines.

In an embodiment, the grater can have other portable items or tools attached to it used in association with grinding. The grater can have symbols in the shape of the tools etched into the surface so that the tools fit, forming a flat surface. The portable items, tools and utensils can be ferromagnetic, or have ferromagnetic features such as a magnet glued to the tool. The portable items can be attached to the ferromagnetic plate though an embedded magnet or a removable magnet. Any portable item used in association with the grater can be ferromagnetic or have a ferromagnetic feature, comprising a lighter, a lighter sleeve, a lighter cover, a lighter wrap, a portable fuel tank, a smoking apparatus, an herb grinder, an ashtray and the like.

While these embodiments have been described with emphasis on the embodiments, it should be understood that within the scope of the appended claims, the embodiments might be practiced other than as specifically described herein.

What is claimed is:

1. A grater for grinding and cutting plant matter or medicines simultaneously comprising:
a. a plate having a plate thickness, the plate comprising:
(i) a first planar surface; and
(ii) a second planar surface opposite the first planar surface;
b. a plurality of first identical shapes etched into the plate at a depth from 5 percent to 95 percent of the plate thickness, but not cut through the plate, each first identical shape of the plurality of first identical shapes having a first inner diameter; and
c. a plurality of second identical shapes positioned adjacent the plurality of first identical shapes forming a textured pattern on the plate, each second identical shape of the plurality of second identical shapes sized to fit within the first inner diameter and extending through the plate, each second identical shape of the plurality of second identical shapes having an identical shape matching the plurality of first identical shapes; and
wherein a first portion of plant matter or medicine is broken down through grinding with the plurality of first identical shapes while a second portion of plant matter or medicine is cut using the plurality of second identical shapes before passing through the plurality of second identical shapes forming a ground and cut material.

2. The grater of claim 1, wherein the plurality of first identical shapes are formed by chemical etching, stamping, or laser etching.

3. The grater of claim 1, wherein the plurality of first identical shapes and the plurality of second identical shapes are formed on the plate in a 1:1 ratio of the plurality of first identical shapes to the plurality of second identical shapes.

4. The grater of claim 1, wherein the first inner diameter ranges from 0.5 mm to 15 mm.

5. The grater of claim 1, wherein the plurality of first identical shapes and the plurality of second identical shapes are polygonal forming a honeycomb pattern.

6. The grater of claim 1, wherein the plurality of second identical shapes increase in size by row on the plate.

7. The grater of claim 1, comprising a plurality of etched symbols formed on either the first planar surface, the second planar surface, or both the first planar surface and the second planar surface, the plurality of etched symbols forming a roughened zone that simultaneously is a message board and a grinding surface.

8. The grater of claim 1, wherein the first planar surface and a third planar surface are formed between the plurality of first identical shapes and the plurality of second identical shapes and wherein the plurality of first identical shapes and the plurality of second identical shapes are parallel to each other.

9. The grater of claim 8, wherein a first side wall connects between the first planar surface and the third planar surface at an angle from 45 degrees to 135 degrees and a second side wall connects between the second planar surface and the third planar surface at an angle from 45 degrees to 135 degrees.

10. The grater of claim 1, wherein the plate thickness is from 0.1 mm to 5 mm.

11. The grater of claim 1, wherein the plurality of first identical shapes and the plurality of second identical shapes are both at least one of: a circular shape, an elliptical shape, a quadrilateral shape, a diamond shape, a pentagonal shape, a hexagonal shape, a heptagonal shape, an octagonal shape, a dodecahedron shape, a triangular shape or another polygonal shape.

12. The grater of claim 1, wherein the plate is flat, curved, or bent.

13. The grater of claim 12, wherein the plate forms at least one of: a lighter cover, a lighter wrap, a lighter sleeve, a lighter case, a smoking apparatus cover, a side of a container used to store ground material, a dividing section in a container used to store the ground material, and a top of a container used to the store ground material.

14. The grater of claim 1, wherein the plate comprises at least one of: a ferromagnetic material, a metal material, a plastic material, a composite material, a rubberized material, a heat resistant material, a wooden material, a plant-based material, a stone material, and a quartz material.

15. The grater of claim 1, wherein the plate is removably attached to a portable item having a fourth planar surface, the portable item comprising at least one of: a spoon, a fork, a spork, a knife, a packing tool, a poker tool, a scraper tool, a tweezer tool, a needle tool, a scalpel tool, a small portable tool, a small portable utensil, a lighter, a lighter sleeve, a portable fuel tank, a smoking apparatus, an ashtray, and a herb grinder.

16. The grater of claim 8, wherein the plate is removably inserted into a heat resistant cover that covers at least a portion of at least one of: the first planar surface, the second planar surface, the third planar surface, and a portable item having a fourth planar surface.

17. The grater of claim 15, wherein at least one magnet is affixed to at least one of: the first planar surface, the second planar surface, the third planar surface, and the portable item having the fourth planar surface.

18. The grater of claim 1, wherein a pattern of raised grating points is formed on the first planar surface between each of the plurality of first identical shapes.

19. The grater of claim 1, wherein the plurality of first identical shapes are a different shape than the plurality of second identical shapes.

20. The grater of claim 1, further comprising a magnetic lighter system removably attached to the grater and configured to magnetically engage the grater for grinding and cutting plant matter, wherein the magnetic lighter system comprises at least one of:
a. a lighter with at least one embedded magnet;
b. a lighter cover that fits over at least a portion of the lighter, the lighter cover comprising at least one additional embedded magnet;
c. a lighter wrap that wraps around at least a portion of the lighter, the lighter wrap comprising the at least one magnet removably secured to the lighter beneath the lighter wrap; or
d. a lighter sleeve that slides over at least a portion of the lighter, the lighter sleeve comprising the at least one embedded magnet.

21. The grater of claim 20, wherein the magnetic lighter system further comprising a ferromagnetic plate having a ferromagnetic plate thickness, wherein the grater and magnetic lighter systems comprises:
a. a first surface;
b. a second surface opposite the first surface;
c. a second plurality of first identical shapes cut into the ferromagnetic plate at a depth from 5 percent to 95 percent of the ferromagnetic plate thickness, but not through the ferromagnetic plate, each first identical shape of the second plurality of first identical shapes having a second inner diameter; and
d. a second plurality of second identical shapes positioned adjacent the second plurality of first identical shapes forming a second textured pattern on the ferromagnetic plate, each second identical shape of the second plurality of the second identical shapes sized to fit within the second inner diameter of the second plurality of first identical shapes and extending through the ferromagnetic plate; and
e. wherein another first portion of plant matter or medicine is broken down through grinding with the second plurality of first identical shapes while another second portion of plant matter or medicine is cut using the second plurality of second identical shapes before passing through the second plurality of second identical shapes forming the ground and cut material.
